(19) United States
(12) Patent Application Publication
(10) Pub. No.: US 2022/0281621 A1
(43) Pub. Date: Sep. 8, 2022

(54) VEHICLE AND METHOD FOR PROPELLING VEHICLE

(71) Applicant: Ian Clague, Bradford-on-Avon (GB)

(72) Inventor: Ian Clague, Bradford-on-Avon (GB)

(21) Appl. No.: 17/201,087

(22) Filed: Mar. 15, 2021

(30) Foreign Application Priority Data
Mar. 8, 2021 (GB) GB2103166.1

(51) Int. Cl. B64G 1/40; G21B 1/05; G21K 1/00; G21B 1/23

(52) U.S. Cl. CPC B64G 1/409; G21B 1/057; G21K 1/00; G21B 1/23

(57) ABSTRACT

There is disclosed a vehicle and a method for propelling the vehicle comprising a propulsion arrangement. The propulsion arrangement includes a chamber arrangement that is configured to store antimatter therein by using magnetic and/or electrostatic fields. The chamber arrangement and a centre of gravity of the vehicle are positioned at a relative distance from each other to form a matter-antimatter dipole when in operation. The matter-antimatter dipole provides a propulsion force to the vehicle. Optionally, the vehicle is a space vehicle (namely a spacecraft, a satellite or similar).

### TECHNICAL FIELD

The present disclosure relates to vehicles comprising antimatter propulsion arrangements. Moreover, the present disclosure relates to methods for (namely, to methods of) propelling vehicles using antimatter propulsion arrangements. Furthermore, the present disclosure relates to apparatus that are configured to provide antimatter propulsion.

### BACKGROUND

Space exploration and associated space technology are one of the greatest achievements of modern science. Space exploration and space travel have helped achieve scientific breakthroughs in fields of healthcare, communication, weather forecasting, and the like. Despite significant achievements and advancements in technology relating to space travel and exploration, there exists significant challenges that limit capabilities of the human race to explore effectively and utilise the full potential of outer space, for example to utilise outer space existing at great distances from the earth.

In order to travel great distances from the earth into outer space, for example to other planets than the earth, to other solar systems or even eventually to other galaxies, more advanced space vehicles and propulsion mechanisms need to be developed that can provide propulsion for extended periods of time for travelling aforesaid great distances. Furthermore, in order to travel such great distances, it is highly desirable to achieve space vehicle velocities that are substantially greater than velocities that contemporary space vehicles are capable of achieving. A primary challenge that limits human ability to perform space exploration is a requirement of a space vehicle to have a physical propellant or have some type of reaction mass to be ejected from the space vehicle to provide propulsion to the space vehicle (name, space craft). As the space vehicle is limited by an amount of weight that it may be able to carry into outer space, the amount of physical propellant or reaction mass that can be carried in the space vehicle is also limited, thereby limiting the distances the space vehicle is able to travel.

In conventional Newtonian physics, a mass of a given body is a positive parameter, wherein bodies with positive masses are mutually attracted to each other. Such forces cause planets in the solar system to revolve in elliptical orbits around the Sun and spiral galaxies to revolve around black holes at the centres of such galaxies. However, there exists antimatter in the universe that was generated at the Big Bang. Such antimatter has a negative mass, wherein a body of positive mass (i.e., matter) and a body with negative mass (i.e., antimatter) repel each other. Furthermore, momentum and kinetic energy of a moving antimatter body are also negative parameters. Notably, as matter and antimatter have opposing properties, when matter and antimatter collide, annihilation occurs releasing a large amount of energy. For example, a photon has components therein of matter and anti-matter.

Recent studies and experiments by physicists have suggested use of antimatter for providing propulsion to space vehicles. One such technique that has been suggested concerns utilising hypothetical collision sails for providing propulsion to space vehicles. Such a technique assumes the medium of space as a form of isotropic medium which is constantly impinging on all sides of a given space vehicle. Therefore, it is hypothesised that if matter-antimatter collisions on the front of a space craft could be lessened and/or the collisions on the back enhanced, a net propulsive force would result. As observed from various studies and experiments, small quantities of antimatter can be generated by using high-energy colliders, using particles accelerated to huge energies, for example in an order of MeV (Mega electron Volts) or even GeV. Therefore, antimatter is a limited resource and such techniques use antimatter as a propellant that can eventually be exhausted, thereby again limiting the distances of space travel.

The United States Patent Application Ser. No. 2002/0085661 titled “PROPULSION SYSTEM FOR SPACE VEHICLE” describes a propulsion system for a space vehicle designed as a fully self-contained system which does not eject particles to implement propulsion. The patent application provides that propulsion forces are generated by changing a mass of rings of charged particles by accelerating the rings of charged particles to velocities near the speed of light and back to a rest or near rest speed in an oscillatory manner. The propulsion system comprises closed tubes such as cyclotrons, wherein the rings are located within the tubes and are composed of charged particles in a form of electrons, positrons, protons, or plasmas. Electrostatic and magnetic fields are produced in the manner utilized with cyclotrons to rotate the rings of charged particles about a central axis of each of the tubes. The particles initially rotate slowly (and they are rotated in opposite directions, for example, the upper ring rotating clockwise and the lower ring rotating counterclockwise). The rotational velocity of the particles of the engine operating cycle is slow; moreover, the comparative mass of the particles is low. The rings of particles then are moved upward to a position near the top of the respective circular tubes comprising the engines. The rotational velocity of the particles then is increased while they are in this position until the particles achieve a very high relative rotational velocity.

Once the high rotational velocity has been achieved, increasing the mass of the particles significantly by rotating the rings of particles to a near light speed, in opposite directions of rotation has been achieved, electromagnetic forces are used to move the particles downwardly in the engine compartments. This imparts an upward thrust on the overall vehicle. Moreover, such a propulsion arrangement is complex and bulky to implement.

Therefore, in light of the foregoing discussion, there exists a need to overcome the aforementioned drawbacks associated with conventional space crafts.

### SUMMARY

The present disclosure seeks to provide a vehicle comprising an improved propulsion arrangement. The present disclosure also seeks to provide an improved method for propelling a vehicle comprising a propulsion arrangement. The propulsion arrangement comprises a dipole inertial drive, wherein two poles of matter and antimatter create a gravitational potential gradient around the vehicle which causes it to accelerate. An aim of the present disclosure is to provide a solution that overcomes at least partially the aforesaid problems encountered in prior art.

In one aspect, the present disclosure provides a vehicle comprising a propulsion arrangement, wherein the propulsion arrangement includes a chamber arrangement that is configured to store antimatter (for example positrons) therein by using magnetic and/or electrostatic fields, wherein the chamber arrangement and a centre of gravity of the vehicle are positioned at a relative distance from each other to form a matter-antimatter dipole when in operation, and wherein the matter-antimatter dipole provides a propulsion force to the vehicle.

The invention is of advantage in that when the amount of antimatter present is sufficient, a repulsive force can be generated that can levitate and propel the vehicle.

In another aspect, an embodiment of the present disclosure provides a method for propelling a vehicle comprising a propulsion arrangement, wherein the method includes:

(i) arranging for the propulsion arrangement to include a chamber arrangement;

(ii) configuring the chamber arrangement to store antimatter (for example, positrons) therein by using magnetic and/or electrostatic fields; and

(iii) arranging for the chamber arrangement and a centre of gravity of the vehicle to be positioned at a relative distance from each other to form a matter-antimatter dipole when in operation, wherein the matter-antimatter dipole provides a propulsion force to the vehicle.

Embodiments of the present disclosure substantially eliminate, or at least partially address, the aforementioned problems in the prior art, and enable a vehicle that causes its own propulsion and adjustment of direction of travel without ejection of reaction mass to be realized.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a vehicle, in accordance with an embodiment of the present disclosure;

FIGS. 2 and 3 are schematic illustrations of a vehicle (for example a space vehicle or a vehicle to be used in Earth's atmosphere), in accordance with an embodiment of the present disclosure;

FIG. 4 is a schematic illustration of a tokamak ring-shaped chamber, in accordance with an embodiment of the present disclosure;

FIG. 5 is a schematic illustration of a propulsion arrangement, in accordance with an embodiment of the present disclosure;

FIG. 6 is a schematic illustration of a buffer-gas trap, in accordance with an embodiment of the present disclosure;

FIG. 7 is a flowchart depicting steps of a method for propelling a vehicle, in accordance with an embodiment of the present disclosure; and

FIGS. 8 to 12 are schematic illustrations of underlying physical mechanism that are relevant to understanding embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art will recognize that other embodiments for carrying out or practising the present disclosure are also possible.

In one aspect, the present disclosure provides a vehicle comprising a propulsion arrangement, wherein the propulsion arrangement includes a chamber arrangement that is configured to store antimatter (for example, positrons) therein by using magnetic and/or electrostatic fields, wherein the chamber arrangement and a centre of gravity of the vehicle are positioned at a relative distance from each other to form a matter-antimatter dipole when in operation, and wherein the matter-antimatter dipole provides a propulsion force to the vehicle.

In another aspect, an embodiment of the present disclosure provides a method for propelling a vehicle comprising a propulsion arrangement, wherein the method includes:

(i) arranging for the propulsion arrangement to include a chamber arrangement;

(ii) configuring the chamber arrangement to store antimatter (for example, positrons) therein by using magnetic and/or electrostatic fields; and

(iii) arranging for the chamber arrangement and a centre of gravity of the vehicle to be positioned at a relative distance from each other to form a matter-antimatter dipole when in operation, wherein the matter-antimatter dipole provides a propulsion force to the vehicle.

The present disclosure provides a vehicle including a propulsion arrangement, and a method of propelling the vehicle using the propulsion arrangement. The vehicle as described in the present disclosure causes its own propulsion by employing a matter-antimatter dipole without ejection of any reaction mass from the vehicle. The present disclosure further provides a compact and practical antimatter propulsion arrangement that can be used in vehicles, for example in space vehicles (namely, spacecrafts) or deep-space satellites. Furthermore, acceleration and direction of travel of the vehicle as described in the present disclosure can beneficially be controlled by adjusting position of the chamber arrangement and without use of any physical propellants. Notably, the vehicle described herein is suited for extended periods of travel. In an implementation wherein the vehicle is a space vehicle, the antimatter propulsion arrangement of the present disclosure presents a light-weight, sustainable apparatus for propelling the space vehicle.

Pursuant to embodiments of the present disclosure, there is provided a vehicle, and a method of propelling the vehicle using antimatter. Herein, the term “vehicle” refers to an apparatus that can be used for transporting people or cargo using a propulsion force. Notably, the propulsion force has to be of a higher magnitude to balance forces acting on the vehicle, such as the inertial force, to impart motion to the vehicle. Examples of the vehicle may include, but are not limited to, motor vehicles, railed vehicles, watercraft, aircraft. In an embodiment, the vehicle is a space vehicle (namely, spacecraft).

Notably, modern physics research has identified that a force of gravitational repulsion exists between matter and antimatter. It is this force that is being harnessed in the dipole matter-antimatter drive to provide propulsion for the aforesaid vehicle. Moreover, the strength of this repulsive gravitational force has been found to be much stronger than Newtonian gravity. This means that a relatively small amount of antimatter provides a large force of propulsion to the body of the spacecraft, which consists of matter. Indeed, the repulsive gravitational force has been found to be 10⁴⁵ (ten to the power 45) times more powerful than Newtonian gravity.

The vehicle comprises a propulsion arrangement. The propulsion arrangement includes a chamber arrangement that is configured to store antimatter therein, for example positrons therein, by using magnetic and/or electrostatic fields. Herein, the term “positron” refers to antimatter part of the electron having an electric charge of +1e and a spin of 1/2. It will be appreciated that when antimatter is contacted by electrons or matter particles, annihilation occurs generating two photons. Therefore, positrons are to be generated in vacuum conditions and suspended in the chamber arrangement using magnetic and/or electrostatic fields in a manner that positrons are not contacted by any matter.

In an embodiment, the chamber arrangement is beneficially implemented as a tokamak ring-shaped chamber that is configured to store the antimatter along an annular central magnetic axis of the tokamak ring-shaped chamber. Notably, the tokamak ring-shaped chamber is shaped in the form of a ring or a torus, wherein toroidal field coils are helically wound around the torus to induce a magnetic field along the annular central magnetic axis thereof. Additionally, or alternatively, optionally, the tokamak ring-shaped chamber employs permanent neodymium magnets to suspend the positrons in the chamber arrangement. The tokamak ring-shaped chamber provides a high-vacuum, hermetically sealed chamber for the positrons, wherein the positrons continuously spiral around the annular central magnetic axis without touching the walls.

According to an embodiment, the propulsion arrangement further comprises a laser arrangement, a target that is configured to be stimulated by a laser beam generated by the laser arrangement to produce positrons, and a deflector arrangement that is configured to guide the positrons generated at the target into the chamber arrangement. Notably, the laser beam generated by the laser arrangement is directed towards the target, wherein the laser beam ionizes and accelerates electrons, which are driven through the target. Optionally, the laser beam may be a pulsed laser beam or a laser beam having a high intensity. Herein, as the electrons are driven through the target, the electrons interact with nuclei of the target, wherein the nuclei serve as a catalyst to create positrons. The electrons emit packets of energy, wherein the energy decays into matter and antimatter, following the predictions by Einstein's equation relating to matter and energy (E=mc²). Notably, by concentrating the energy in space and time, the laser beam produces positrons in a high density. The target may have a thickness in an order of a few millimetres and may be manufactured using Gold, Erbium or Tantalum, for example. As the positrons are generated, the deflector arrangement guides the positrons into the chamber arrangement. Optionally, the target is spatially integrated with the tokamak ring-shaped chamber.

In an embodiment, the target further comprises a composite Copper-Gold, Copper-Erbium or Copper-Tantalum structure that is irritated with pulsed laser beams, wherein the composites upon irradiation generate intense laser beams that subsequently excite the Gold, Erbium or Tantalum target to generate antimatter.

Optionally, the target is provided with one or more fluid channels for accommodating a flow of a cooling fluid therethrough for cooling the target. More optionally, the target may be a Gold sheet, an Erbium sheet or a Tantalum sheet that is bonded to a heat sink, wherein the heat sink includes internal fluid channels therein for accommodating a flow of a cooling fluid for cooling the heat sink and its Gold, Erbium or Tantalum sheet. It will be appreciated that when blasted with accelerated particles or laser beams, the target may reach a high temperature, unless cooled by using a cooling fluid as aforementioned. The one or more internal fluid channels for accommodating a flow of cooling fluid reduces an operating temperature of the target, thereby enabling a safe operation thereof.

Optionally, the target is raster scanned by a laser beam or high-energy particle beam over its entire area rather than being maintained on just one area of the target. Beneficially, such raster scanning ensures that thermal dissipation occurs over the entire area of the target, thereby avoiding localized sputtering, evaporation or ablation of the target. This can be achieved by scanning the beam or actuating the target, or a mixture of both.

Optionally, the vehicle further comprises a control feedback loop wherein vehicle acceleration is served back to the particle to the laser arrangement exciting the target.

Optionally, the laser arrangement includes one or more Q-switched lasers that are configured to generate light pulses that cause the positrons to be generated in the target. Notably, the Q-switched laser produces light pulses of high peak power, specifically in an order of gigawatts. The light pulses produced by the one or more Q-switched lasers generally produce light pulses that last a few nanoseconds. Such short operational time allows greater control over the generation of positrons at the target. It will be appreciated that a Q-switched laser of high intensity may generate a high ratio of positrons to electrons, possibly approaching a neutral “pair plasma” with equal numbers of positrons and electrons.

According to another embodiment, the propulsion arrangement further comprises a particle accelerator arrangement, a target that is configured to be stimulated by a particle beam generated by the particle accelerator arrangement to produce positrons, and a deflector arrangement that is configured to guide the positrons generated at the target into the chamber arrangement. Notably, the particle accelerator arrangement uses electromagnetic fields to propel charged particles, such as protons or electrons, to very high speeds and energies, and to contain them in well-defined beams. For example, the particle accelerator arrangement is susceptible to being implemented using an epicyclotron as described in a granted US patent (U.S. Pat. No. 8,138,692B2; MacDonald-Bradley). In the US patent, there is disclosed a method for accelerating and manipulating charged particles into dosed orbits by subjecting them to crossed magnetic and electric fields, wherein the method includes:) providing generally radial non-axisymmetric electric fields by applying
i) differential electrical potentials to a central electrode and a series of outer electrodes, and
ii) providing means to produce a magnetic field generally orthogonal to the electric fields, then
iii) causing the rotation of the electric fields by the charging and discharging, or partial discharging, of the outer electrodes in a synchronous manner.

Examples of the epicyclotron have been constructed in practice and function very efficiently to provide high-energy particles suitable for generating antimatter from targets. Subsequently, the charged particles are either smashed onto a target or against other particles circulating in an opposite direction, thereby generating beams of electrons, positrons, protons, and antiprotons, interacting with each other or with the simplest nuclei at the highest possible energies, generally hundreds of GeV or more. As the positrons are generated, the deflector arrangement guides the positrons into the chamber arrangement. It will be appreciated that electrons are guided into the chamber arrangement in high-vacuum conditions, wherein the target, the deflection arrangement and the interior of the chamber arrangement needs to be evacuated of air when the propulsion arrangement is in operation.

Optionally, the deflector arrangement includes one or more electromagnetic and/or electrostatic lenses for focusing the positrons generated at the target as a positron beam to feed into the chamber arrangement. Notably, the deflector arrangement ensures that the positrons generated at the target do not contact any matter and are focused as a positron beam into the chamber arrangement to be suspended therein using magnetic and/or electrostatic fields. The electromagnetic lens used herein may be similar in its operation to electromagnetic lenses as used in a conventional scanning electron microscope (SEM). Furthermore, the deflector arrangement is maintained at a potential difference in comparison with the target to draw positrons away from the target and into the chamber arrangement. Additionally, optionally, the deflector arrangement may employ permanent neodymium magnets for focusing the positrons into the chamber arrangement.

In an embodiment, the chamber arrangement is implemented as a stellarator that is configured to store the antimatter therein. Notably, the stellarator is a device that employs external magnets to confine positrons therein.

In an embodiment, the chamber arrangement is implemented as a buffer-gas trap comprising a Penning-Malmberg type electromagnetic trap to store antimatter therein. It will be appreciated that magnetic fields required for operating the chamber arrangement need to be of considerable strength since the magnetic fields will effectively bear a weight of the vehicle. The buffer-gas trap, is a type of ion-trap that provides an axial electric charge which prevents the positively charged positrons from escaping radially. Specifically, antimatter is confined in a vacuum inside an electrode structure consisting of a stack of hollow, cylindrical metal electrodes. A uniform axial magnetic field inhibits positron motion radially, and voltages imposed on end electrodes prevent axial loss.

Optionally, the target, for example, a Gold, Erbium or Tantalum target is spatially integrated with the buffer-gas trap; however, it will be appreciated that other metal or metal alloys are optionally used for implementing the target. Notably, the antimatter generated at the target are consequently transferred to the buffer-gas trap for storage. Beneficially, the buffer-gas trap is a compact and light-weight implementation of the chamber arrangement and can be used to propel vehicles such as geostationary satellites to maintain their orbital positions as a function of elapsed time. Furthermore, the buffer-gas trap slows down an antimatter beam to electron-volt energies and accumulates them in the trap.

Pursuant to the embodiments describing the buffer-gas trap, the present disclosure employs a modified Penning-Malmberg trap as the buffer-gas trap that comprises of a series of cylindrically symmetric electrodes of varying inner diameters. These form three distinct trapping stages with three distinct pressure regions, and confine the antimatter axially by producing electrostatic potentials. The antimatter is confined radially by a static magnetic field produced by one solenoid enclosing the electrodes. The principle of this trap is that incoming positrons lose their energy through inelastic collisions with a buffer gas that is introduced in the first stage of the trap. As they cool down, they become trapped in successively deeper potential wells, and progressively lower pressure, until the positrons are confined on the lowest pressure region of the trap, where the lifetime is longer. It is to be noted that in order to trap antimatter with a few tens of electron-volt energy, they must lose enough energy so that they do not exit the trap once they are reflected by the end potential barrier. The cooling mechanism employed in this type of traps is the inelastic collisions a positron undergoes with the buffer gas.

The chamber arrangement and a centre of gravity of the vehicle are positioned at a relative spatial distance from each other to form a matter-antimatter dipole when in operation, and wherein the matter-antimatter dipole provides a propulsion force to the vehicle. Herein, the centre of gravity of the vehicle is a point at which a weight of the vehicle is evenly distributed around it. Notably, a repulsive gravitational force exists between the antimatter in the chamber and the body of the spacecraft which consists of matter. Moreover, this force of repulsive gravity is much stronger than Newtonian gravity. This strong force of repulsive gravity allows the vehicle to accelerate at rates of acceleration up to 5,000 g. Such a rate of acceleration allows the spacecraft to escape Earth's gravitational pull. It will be appreciated that similar arrangements with respect to the matter-antimatter dipole may be employed to overcome forces such as inertial force or frictional force of a road.

It will be appreciated that the present disclosure does not intend to limit the scope of the claims to positrons as the antimatter employed for formation of the matter-antimatter dipole. Notably, antimatter such as antiprotons or antihydrogen may be employed to form a similar matter-antimatter dipole for providing propulsion force to the vehicle.

Optionally, the chamber arrangement is configured to be angularly adjustable with respect to the centre of gravity of the vehicle for steering the vehicle. Specifically, an angular position of the chamber arrangement with respect to the centre of gravity of the vehicle changes a direction of the propulsion force provided by the matter-antimatter dipole. Consequently, a direction of movement of the vehicle can be adjusted accordingly. This allows the vehicle to accelerate in any spatial direction, including upwards and downwards.

Optionally, at least one of rocket thrusters or ion motors are used for steering the vehicle. Notably, rocket thrusters are propulsion devices that expel pressurised gas (such as in cold gas thrusters) or ionized air (such as in electrohydrodynamic thrusters) to control a direction of travel of the vehicle. Similarly, ion motors or ion thrusters create a thrust by accelerating ions using electricity to provide directional assistance to the vehicle.

Optionally, the propulsion force provided by the matter-antimatter dipole is increased by adding positrons to the chamber arrangement, and the acceleration is decreased by dissipating a given amount of the positrons stored in the chamber arrangement. Notably, adding positrons to the chamber arrangement increases the propulsion force provided by the matter-antimatter dipole to the vehicle, thereby providing acceleration to the vehicle. Similarly, the given amount of positrons are dissipated by contacting the positrons with electrons in a controlled manner, thereby reducing the positrons in the chamber arrangement by the given amount and reducing the acceleration provided by the matter-antimatter dipole. Furthermore, energy released from the dissipation of the positrons may be harnessed to support additional functions in the vehicle, such as temperature control, or may be used for deceleration of the vehicle if required.

Optionally, the propulsion force provided by the matter-antimatter dipole is increased by increasing the relative distance between the chamber arrangement and the centre of gravity of the vehicle and the propulsion force is decreased by decreasing the relative distance between the chamber arrangement and the centre of gravity of the vehicle. Such adjustment of the distance can be achieved by using one or more actuators.

Optionally, the propulsion arrangement is configured to provide the propulsion force in a direction that is opposite to a gravitational force of a planet in respect of which the vehicle is operating. Notably, the positrons in the chamber arrangement have a negative mass and therefore, experience a force in a direction that is opposite to the gravitational force of a planet with respect to which the vehicle is operating, for example earth. Therefore, such a force experienced by the positrons is employed to provide propulsion force from the matter-antimatter dipole to the vehicle.

Optionally, the vehicle further comprises a spin-stabilisation arrangement. Notably, the spin-stabilisation arrangement employs mass-expulsion control thrusters to continually nudge the vehicle back and forth within a deadband of allowed attitude error. Additionally, or alternatively, optionally, the spin-stabilisation arrangement comprises electrically powered reaction wheels, also called momentum wheels, that are mounted on three orthogonal axes aboard the vehicle.

It will be appreciated that it is possible to create a continuously propulsive effect by the juxtaposition of negative and positive mass. The poles of negative mass and positive mass may be seen as negative and positive gravitational charges which create a potential gradient between them. The accelerations for positive mass and negative mass align in the same direction and a self-acceleration effect provides propulsion. Notably, antimatter has negative mass and there is a strong gravitational force acting between matter and antimatter.

Since,

$${G}_{s} = \frac{2 ℏc}{{m}_{e}^{2}}$$

This is the Gravitational Constant for strong gravity This compares to:

$$G = \frac{ℏ c}{{M}_{p}^{2}}$$

For Newton's Gravitational Constant, where Mₚ=Planck mass

This strong gravitational force is stronger than the Newtonian gravitational force in the ratio:

$${G}_{s} / G = \frac{2 {M}_{p}^{2}}{{m}_{e}^{2}}$$

or 45 orders of magnitude stronger than the Newtonian gravitational force

For a spacecraft with the same weight as the space shuttle orbiter (110,000 kg), gravitational field produced by negative mass is:

$$\frac{{G}_{s} {m}_{-}}{{d}^{2}}$$

where m_ is the negative mass and d is the distance between the masses.

Gravitational repulsive force felt by the spacecraft is:

$$F = \frac{{G}_{s} {m}^{2} \_}{{d}^{2}} = {M}_{+} a$$

where M₊ is the positive mass of the spacecraft and

$$a = \frac{{G}_{s} {m}^{2} \_}{{M}_{+} {d}^{2}}$$

is the acceleration of the spacecraft.

For example, 3.16×10¹⁶ positrons give an acceleration of 936 g for our spacecraft weighing 110,000 kg.

### DETAILED DESCRIPTION OF THE DRAWINGS

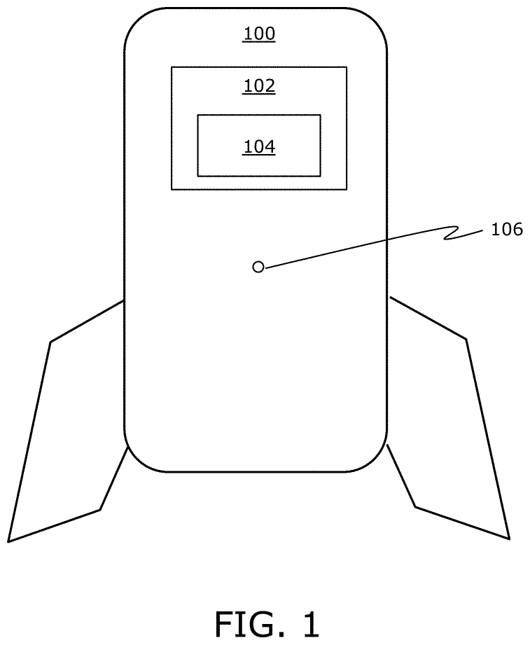

Referring to FIG. 1, there is shown a block diagram of a vehicle 100, in accordance with an embodiment of the present disclosure. The vehicle comprises a propulsion arrangement 102. The propulsion arrangement 102 includes a chamber arrangement 104 that is configured to store antimatter, for example positrons, therein by using magnetic and/or electrostatic fields. The chamber arrangement 104 and a centre of gravity 106 of the vehicle 100 are positioned at a relative distance from each other to form a matter-antimatter dipole when in operation. The matter-antimatter dipole provides a propulsion force to the vehicle 100.

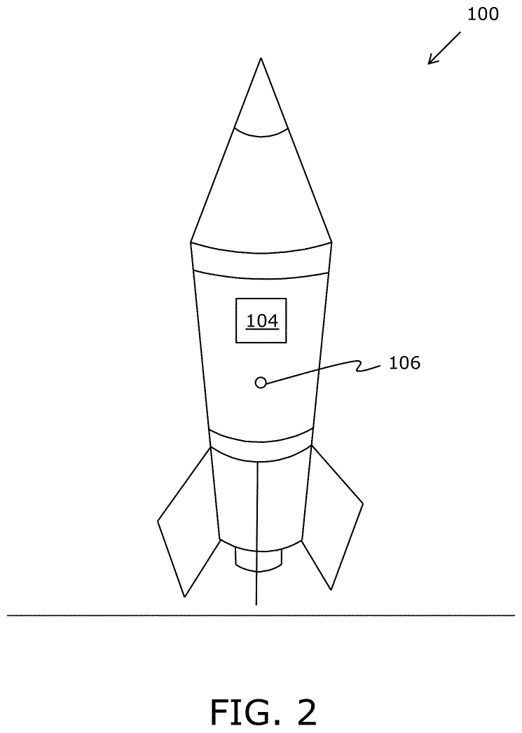

Referring to FIG. 2, there is shown a schematic illustration of the vehicle 100, in accordance with an embodiment of the present disclosure.

Notably, the chamber arrangement 104 and a centre of gravity 106 of the vehicle 100 are positioned at a relative distance from each other to form a matter-antimatter dipole when in operation. The matter-antimatter dipole provides a propulsion force to the vehicle 100.

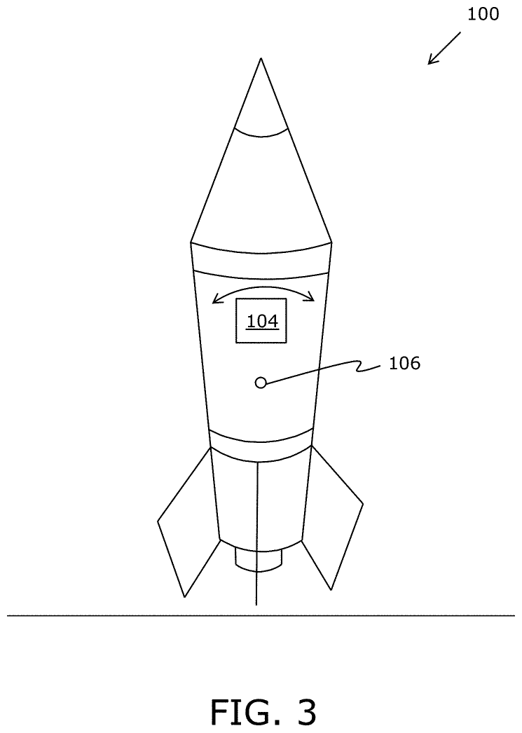

Referring to FIG. 3, there is shown a schematic illustration of the vehicle 100, in accordance with an embodiment of the present disclosure. Herein, the chamber arrangement 104 is configured to be angularly adjustable with respect to the centre of gravity 106 of the vehicle 100 for steering the vehicle 100.

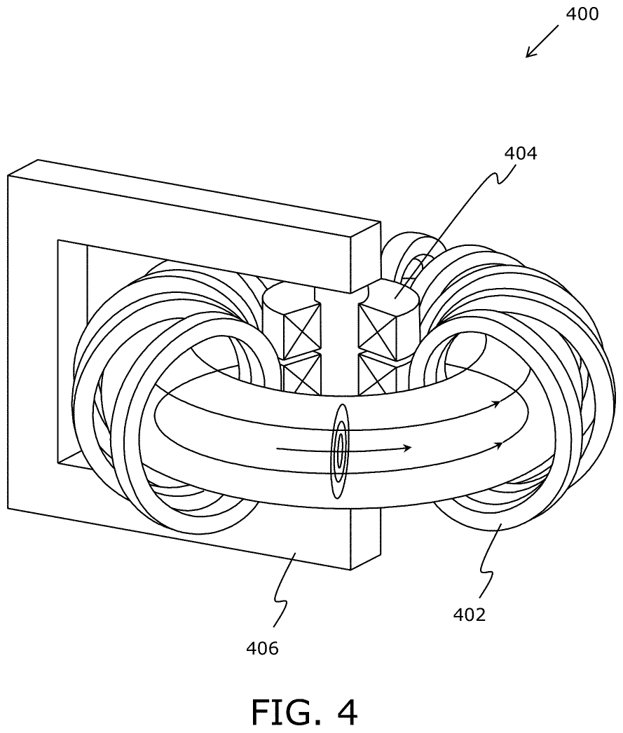

Referring to FIG. 4, there is shown a schematic illustration of a tokamak ring-shaped chamber 400, in accordance with an embodiment of the present disclosure. As shown in FIG. 4, the tokamak ring-shaped chamber 400 is shaped in the form of a ring or a torus, wherein toroidal field coils 402 are helically wound around the torus to induce a magnetic field along the annular central magnetic axis thereof. The tokamak ring-shaped chamber 400 further comprises a primary winding 404 and a transformer yoke 406.

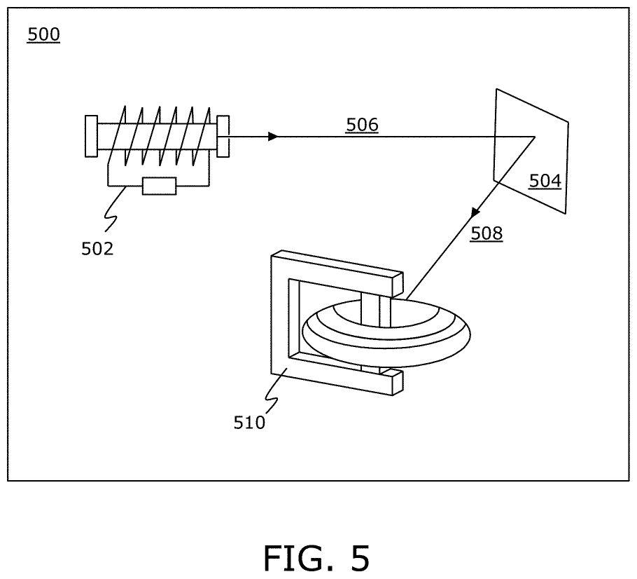

Referring to FIG. 5, there is shown a schematic illustration of a propulsion arrangement 500, in accordance with an embodiment of the present disclosure. The propulsion arrangement 500 comprises a laser arrangement 502, a target 504 that is configured to be stimulated by a laser beam 506 generated by the laser arrangement 502 to produce the antimatter 508, and a deflector arrangement that is configured to guide the antimatter 508 generated at the target 504 into the chamber arrangement, such as the tokamak ring-shaped chamber 510. From the foregoing, it will be appreciated that an epicyclotron is susceptible to being used in substitution for, or in addition to, the laser arrangement 502. An example of a practical epicyclotron is described in a granted US patent U.S. Pat. No. 8,138,692 B2 that is hereby incorporated by reference. The laser arrangement 502 includes one or more Q-switched lasers that are configured to generate light pulses that cause the antimatter 508 to be generated in the target 504. The target 504 may be manufactured using Gold, Erbium or Tantalum, although other heavy elements can alternatively be used.

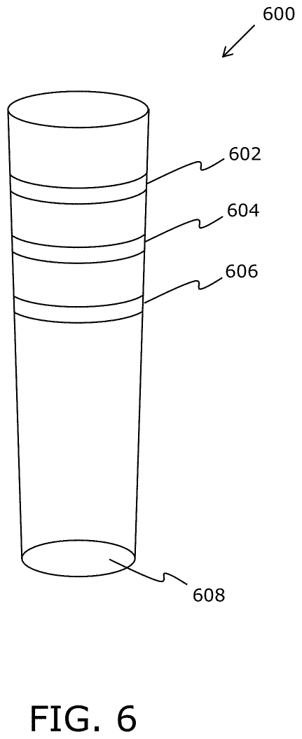

Referring to FIG. 6, there is shown a schematic illustration of a buffer-gas trap 600, in accordance with an embodiment of the present disclosure. The buffer-gas trap 600 is implemented as a modified Penning-Malmberg trap comprising a series of cylindrically symmetric electrodes, such as the electrodes 602, 604 and 606, of varying inner diameters. The electrodes 602, 604 and 606 form three distinct trapping stages with three distinct pressure regions, and confine the antimatter axially by producing electrostatic potentials. Furthermore, the target 608, for example, a Gold, Erbium or Tantalum target, is spatially integrated with the buffer-gas trap 600. Notably, the antimatter generated at the target 608 are consequently transferred to the buffer-gas trap for storage.

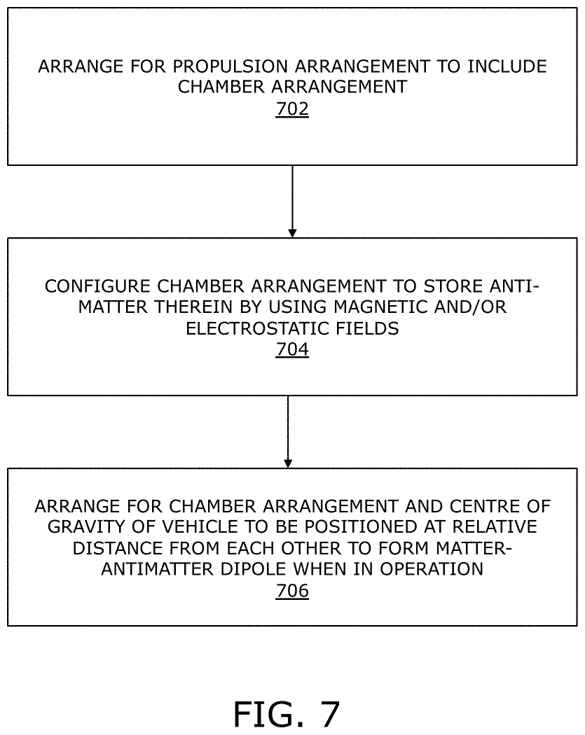

Referring to FIG. 7, there is illustrated a flowchart depicting steps of a method for propelling a vehicle, in accordance with an embodiment of the present disclosure. The vehicle (such as the vehicle 100 of FIG. 1) comprises a propulsion arrangement (such as the propulsion arrangement 102 of FIG. 1). At a step 702, the propulsion arrangement is arranged to include a chamber arrangement. At a step 704, the chamber arrangement is configured to store positrons therein by using magnetic and/or electrostatic fields. At a step 706, the chamber arrangement and a centre of gravity of the vehicle are arranged to be positioned at a relative distance from each other to form a matter-antimatter dipole when in operation. The matter-antimatter dipole provides a propulsion force to the vehicle.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

Appendix

The question of whether the photon is an elementary particle or composite has been a matter of debate for almost 100 years since Louis De Broglie published his paper, “A Tentative Theory of Light Quanta” in 1924. De Broglie wrote “Naturally, the light quantum must have an internal binary symmetry”. The composite theory is more descriptive of reality than the elementary theory. Perkins (2014) finds that the composite theory predicts the Maxwell equations, while the elementary photon has been created to reflect them. He continues “In the elementary theory, it is difficult to describe the electromagnetic field with the four-component vector potential. This is because the photon has only two polarization states. This problem does not exist with the composite photon theory.”

Gauthier (2019) has done extensive work in this area and elaborates a composite model consisting of an electron-positron pair spinning around each other in helical motion. He finds that the parameters of energy, frequency, wavelength and helical radius of each spin-1/2, half photon composing the double-helix photon remain the same in the transformation of the half photons into the relativistic electron and positron quantum vortex models. Villata (2011) has transformed matter into antimatter in the equations of both electrodynamics and gravitation. Starting from the CPT invariance of physical laws, in the former case, the result is the well-known change of sign of the electric charge. In the latter, he finds that the gravitational interaction between matter and antimatter is a mutual repulsion, namely antigravity appears as a prediction of general relativity when CPT is applied. This result supports cosmological models attempting to explain the accelerated expansion of the Universe in terms of a matter-antimatter repulsive interaction.

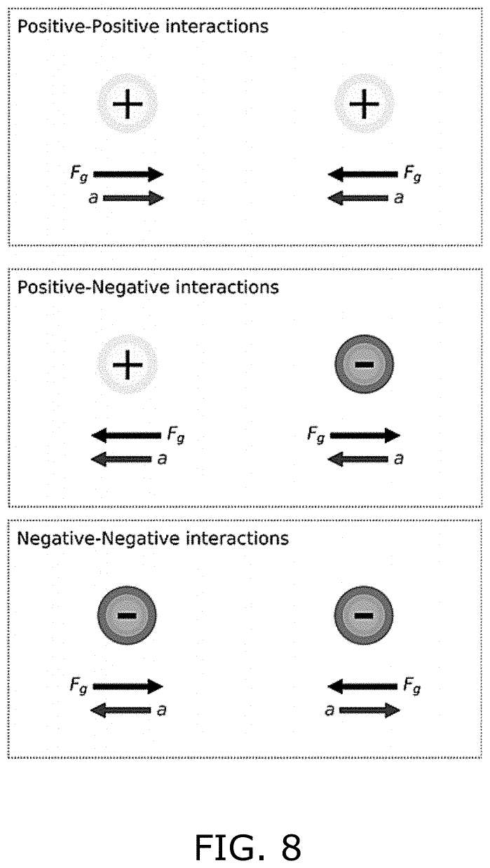

Using the work of Bondi (1957), we may interpret this finding as negative mass of the only type compatible with general relativity. The interactions of such negative mass are given in FIG. 8. For the negative mass, the acceleration is in the opposite direction to the gravitational force.

Experimental Evidence

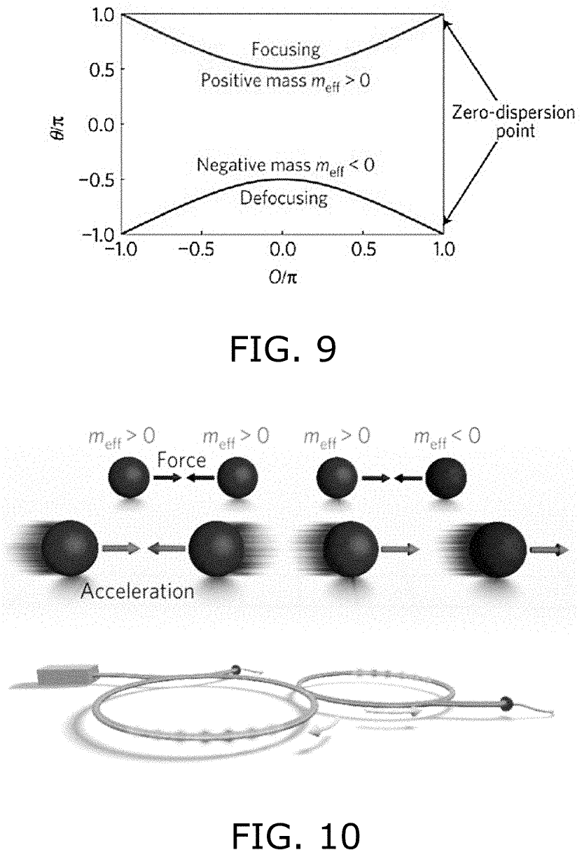

For experimental confirmation of the photon's composition as two symmetrical half-photons, one of positive mass and one of negative mass, we can look to Wimmer, Regensberger et al. (2103). They find symmetrical halves of negative and positive mass on a dispersion diagram for light pulses interacting (FIG. 9). The laser pulses also display runaway self-acceleration which is expected from FIG. 8. for the positive-negative mass interaction in which the accelerations of the two masses are in the same direction (FIG. 10).

That the photon consists of an electron with positive and a positron with negative mass explains why the rest mass of the photon is zero. Runaway motion between positive and negative mass explains why photons always travel at light speed.

In the absence of an electrical field, the defocusing behaviour of positron beams is evidence of the negative mass to negative mass interaction. Negative masses accelerate away from each other.

In addition, the elliptical polarization of light is experimental evidence for the composite photon. This shows the electromagnetic field to be a 4-vector. The elementary photon theory predicts only two states of (circular) polarization.

### Charges Follow a Potential Gradient

We do not find, however, that the positron of negative mass will react inversely to the electromagnetic force. This would be inconsistent with experimental evidence for the electromagnetic interaction of antimatter

(Gabrielse et al. 1999). There is no gravitational potential gradient in spectroscopy experiments to determine the mass/charge ratio of antimatter particles. Since negative mass was completely unexpected, the experimental set-up, which is largely unchanged since 1897, was not designed to detect it.

Equality of Forces Acting on the Electron-Positron Pair

We now investigate the forces acting on the electron-positron pair. The centripetal force is equal to the Coulomb force acting between the negatively charged electron and the positively charged positron. In addition, from the arguments above, a repulsive gravitational force between the matter and antimatter particles is equal to the attractive Coulomb force.

We have: Centripetal force =Coulomb force =Gravitational force For two half-photons separated by a distance

$$D = \frac{λ}{π} ,$$

wherein λ is wavelength of the photon

$$\begin{matrix}{F}_{centripetal} = 2 π \frac{c}{λ} \cdot \frac{1}{2} \cdot \frac{h}{λ} \\ = \frac{π c h}{{λ}^{2}}\end{matrix}$$

$$\begin{matrix}For λ = ϖ D , \\ = \frac{π c h}{{D}^{2} {π}^{2}} \\ = \frac{c h}{{D}^{2} π} \\ = \frac{G {m}_{e} {m}_{p}}{{D}^{2}} = {F}_{g r a v i t a t i o n a l}\end{matrix}$$

wherein mₚ is mass of a positron

$$G = \frac{c h}{π {m}_{e}^{2}}$$

$${G}_{s} = \frac{2 ℏ c}{{m}_{e}^{2}}$$

This is the Gravitational Constant for strong gravity This compares to:

$$G = \frac{ℏ c}{{M}_{p}^{2}}$$

For Newton's Gravitational constant, wherein Mₚ=Planck mass

This indicates the existence of a strong version of the gravitational force operating inside the composite photon consisting of an electron-positron pair.

This strong gravitational force is stronger than the Newtonian gravitational force in the ratio:

$$\frac{{G}_{s}}{G} = \frac{2 {M}_{p}^{2}}{{m}_{e}^{2}}$$

Or 45 orders of magnitude stronger than the Newtonian gravitational force. In other words, a small amount of antimatter arranged with matter in an antimatter-matter dipole is capable of generating considerable force to propel a spacecraft.

For consistency, we check:

F_{Coulomb}=F_{gravitational}

where Q=e²\sqrt{2/α}=16.6e is the magnitude of the charge on each helically moving half photon, α=fine structure constant and ε₀ is the permittivity of the vacuum.

$$\frac{{Q}^{2}}{4 {πε}_{0} {D}^{2}} = \frac{{G}_{s} {m}_{e}^{2}}{{D}^{2}}$$

$${G}_{s} = \frac{2 {e}^{2}}{4 π {ε}_{0} α {m}_{e}^{2}}$$

$$\begin{matrix}Since {e}^{2} = 4 {πε}_{0} ℏ c α \\ = \frac{2 ℏ c}{{m}_{e}^{2}}\end{matrix}$$

This confirms the value of the strong gravitational constant, Gs, so the gravitational force becomes equal to the Coulomb force for

$${G}_{s} = \frac{2 ℏ c}{{m}_{e}^{2}} .$$

Note that the value of Gs is independent of the wavelength of the photon. The strong gravitational force acts on all photons, regardless of their energy.

This provides a unification between the electromagnetic force and the gravitational force, at least in the case of the electron-positron pair.

Is this truly a Unification or simply an Equivalence?

F_{Coulomb}=F_{gravitational}

where Q=e²\sqrt{2/α}16.6e is the magnitude of the charge on each helically moving half photon, α=fine structure constant and ε₀ is the permittivity of the vacuum.

$$\frac{{Q}^{2}}{4 {πε}_{0} {D}^{2}} = \frac{{G}_{s} {m}_{e}^{2}}{{D}^{2}}$$

$$\frac{2 {e}^{2}}{4 {πε}_{0} α {m}_{e}^{2}} = \frac{{G}_{S} {m}_{e}^{2}}{{D}^{2}}$$

$$\frac{2 {e}^{2}}{{G}_{s} {D}^{2}} = \frac{{m}_{e}^{2} \cdot 4 {παε}_{0}}{{D}^{2}}$$

In this representation, we have an electromagnetic force with a gravitational constant is equivalent to strong gravity with an electromagnetic constant.

The two forces are different aspects of the same force, one attractive and the other repulsive.

Consequences of Aforesaid Insight

The electromagnetic force unifies with the strong gravitational force present in composite photons consisting of an electron-positron pair. This strong gravitational force is 45 orders of magnitude stronger than Newtonian gravity.

This unification provides a framework for the unification of the four fundamental forces of nature since the weak force, electromagnetic force and strong force have already been shown to unify. It provides a potential resolution to the Hierarchy Problem of why Newtonian gravity is so much weaker than the other forces.

The composite photon model developed by Gauthier and augmented here give some deep insights into the process of transformation of light into matter and antimatter and the annihilation process of matter and antimatter into photons.

Observational Evidence for Antimatter Having Negative Mass

Composite photons consisting of particle-antiparticle pairs having positive and negative mass provide a physical interpretation at the level of particle physics for the Pair Creation Model of the Universe developed by Choi and Rudra (2104). This gives, for the first time, a fully consistent and lucid explanation of how the universe developed from net zero energy and evolved into the distribution of energy density we observe today.

Indeed, the results of Choi and Rudra's simulation correspond closely with observations:

Energy Distribution in the Universe:

| | WMAP | Simulation | Planck |
|---|---|---|---|
| Matter | 4.6 | 4.5 | 4.9 |
| Dark Matter | 23.3 | 25.1 | 26.8 |
| Dark Energy | 72.1 | 70.3 | 68.3 |

Composite photons consisting of particle-antiparticle pairs having positive and negative mass also provide a physical interpretation at the level of particle physics for the gravitational dipoles proposed by Hadjukovic. Support is also given to negative mass cosmologies developed by J. S. Farnes and Choi and Rudra which correspond well to observational evidence of the interactions and behavior of Dark Matter and Dark Energy. The composite photon development given here thus benefits from the same observational evidence which must be contrasted with the absolute failure of experiments to detect Dark Matter particles or Dark Energy in the laboratory.

Gravity in the Early Universe

$$Strong gravitational force = \frac{{G}_{s} {m}_{e}^{2}}{{D}^{2}} = \frac{2 h C}{2 π {D}^{2}}$$

for the electron-positron pair (the elementary charged particles).

This follows an inverse square law but is independent of the Gravitational constant. It tends to a maximum value of

$${F}_{max} = \frac{2 h c}{2 π {l}_{p}^{2}}$$

as the distance between the electron and positron tends to the Planck length and is repulsive.

$${F}_{max} = \frac{2 h c}{2 π {l}_{p}^{2}} = \frac{2 ℏ c}{ℏ G} \cdot {c}^{3}$$

Where lₚ=Plank length and since

$${l}_{p}^{2} = \frac{ℏ G}{{c}^{3}}$$

$${F}_{max} = \frac{2 {c}^{4}}{G}$$

which is 2 times the Planck Force

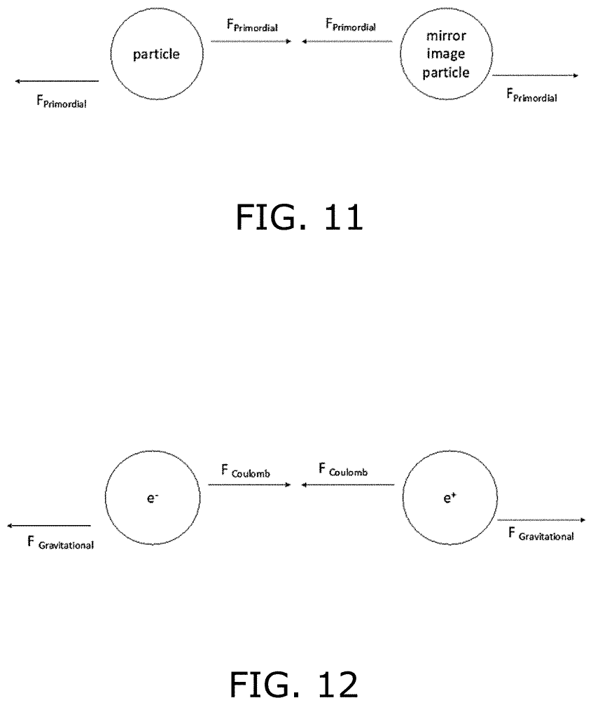

FIG. 11 presents a picture of the primordial force in the early universe. One force is attractive and one force repulsive. A symmetrical beginning for the universe with net-zero energy. These appear to be different aspects of the same primordial force.

From a human perspective, labels appeared as in FIG. 12. This gives us an understanding of how the Coulomb force and gravitational force are different aspects of the same primordial force.

We may also observe that the form of the Coulomb force and the Gravitational force are the same:

$${F}_{C o u l o m b} = {F}_{g r a v i t a t i o n a l}$$

$$\frac{{Q}^{2}}{4 {πε}_{0} {D}^{2}} = \frac{{G}_{s} {m}_{e}^{2}}{{D}^{2}}$$

$$\frac{K . {Charge}^{2}}{{D}^{2}} = \frac{K . {Mass}^{2}}{{D}^{2}}$$

Wherein K=constant

We find K²=(Planck Charge)⁻¹

A symmetrical beginning for the universe with net-zero energy and particles that are mirror images gives positive and negative electromagnetic charges and positive and negative gravitational charges; positive mass for matter and negative mass for antimatter.

Unification Energy

Since photons can take on energies across the electromagnetic spectrum, it does not make sense to think of unification taking place at a particular energy level. Unification between the Coulomb force and the gravitational force takes place through a variation in the value of the gravitational constant, which is much higher for the strong gravitational force between the electron and the positron.

The composite photon consisting of a positive mass particle and a negative mass antiparticle allows gravity to be combined with the Standard Model of particle physics for the first time.

Range of the Strong Gravitational Force

The strong gravitational force discovered here is present in all photons. Since the electromagnetic spectrum covers wavelengths ranging from 100,000 km to 1 picometre, then the force is not microscopic in range but rather operates across a wide range of distances as Newtonian gravity does.

Expansion of Einstein Field Equations to Include Vector Gravity

We can now contemplate the expansion of Einstein's Field Equations to include the strong gravity found here, which is repulsive between positive mass and negative mass. The deep relationship to Coulomb's Law shown here provides the basis for this expansion.

Tentatively, we can say that an equivalence to Maxwell's equations can be developed since we may now view gravity as gravitational charge having positive and negative charges in the same manner as electromagnetism. We may develop Gauss's law for gravity from Newton's law in the same manner that Gauss's law can be developed from Coulomb's law.

Nieto and Goldman (1991) highlight the possibility of vector gravity for antimatter. Their study concludes that experimental evidence does not exclude this outcome.

Gauss's law for gravity gives:

∇.g=4πGₛρ

where ∇ is the divergence, g is the gravitational field and ρ is the mass density. Quantities may be positive or negative.

More generally, we note that Maxwell's equations for electromagnetism may be developed from Coulomb's Law plus the Lorenz invariance transformations of Special Relativity. In a parallel manner, an extended version of Einstein's Field Equations can be developed from Newton's Law of Gravitation plus Special Relativity. This extension will include interactions between the positive and negative gravitational charges and reflect the strong gravitational constant calculated here for the interaction between positive and negative mass.

Conclusion

A deep relationship is identified between the Coulomb force and Gravity. We demonstrate how this relationship arises through the composite photon. A gravitational constant for strong gravity is calculated from the relationship. The gravitational force is repulsive between matter having positive mass and antimatter having negative mass. Experimental evidence for the composite nature of the photon and for antimatter having negative mass is presented. The striking equivalence between mass and charge is explored. It is postulated that the Coulomb force and gravity are different aspects of the same primordial force. Implications are given for the expansion of Einstein's Field Equations to include vector gravity.

The APPENDIX here provides a theoretical basis for apparatus described in the foregoing for realising practical workable embodiments of the present disclosure. Component parts of the embodiments are contemporarily commercially available and, when configured together, provide a resulting force that is of a magnitude that is suitable for propelling vehicles to a very high velocity, for example eventually approaching close to the speed of light.

1. A vehicle comprising a propulsion arrangement, wherein the propulsion arrangement includes a chamber arrangement that is configured to store antimatter therein by using magnetic and/or electrostatic fields, wherein the chamber arrangement and a centre of gravity of the vehicle are positioned at a relative distance from each other to form a matter-antimatter dipole when in operation, and wherein the matter-antimatter dipole provides a propulsion force to the vehicle.

2. The vehicle of claim 1, wherein the antimatter comprises positrons.

3. The vehicle of claim 1, wherein the chamber arrangement is implemented as a tokamak ring-shaped chamber that is configured to store the antimatter along an annular central magnetic axis of the tokamak ring-shaped chamber.

4. The vehicle of claim 1, wherein the propulsion arrangement further comprises a laser arrangement, a target that is configured to be stimulated by a laser beam generated by the laser arrangement to produce the antimatter, and a deflector arrangement that is configured to guide the antimatter generated at the target into the chamber arrangement.

5. The vehicle of claim 4, wherein the laser arrangement includes one or more Q-switched lasers that are configured to generate light pulses that cause the antimatter to be generated in the target.

6. The vehicle of claim 1, wherein the propulsion arrangement further comprises a particle accelerator arrangement, a target that is configured to be stimulated by a particle beam generated by the particle accelerator arrangement to produce the antimatter, and a deflector arrangement that is configured to guide the antimatter generated at the target into the chamber arrangement.

7. The vehicle of claim 4, wherein the deflector arrangement includes one or more electromagnetic and/or electrostatic lenses for focusing the antimatter generated at the target as an antimatter beam to feed into the chamber arrangement.

8. The vehicle of claim 1, wherein the chamber arrangement is configured to be angularly adjustable with respect to the centre of gravity of the vehicle for steering the vehicle.

9. The vehicle of claim 1, wherein at least one of rocket thrusters or ion motors are used for steering the vehicle.

10. The vehicle of claim 1, wherein the propulsion force provided by the matter-antimatter dipole is increased by adding positrons to the chamber arrangement, and the acceleration is decreased by dissipating a given amount of the antimatter stored in the chamber arrangement.

11. The vehicle of claim 1, wherein the propulsion arrangement is configured to provide the propulsion force in a direction that is opposite to a gravitational force of a planet in respect of which the vehicle is operating.

12. A method for propelling a vehicle comprising a propulsion arrangement, wherein the method includes:
arranging for the propulsion arrangement to include a chamber arrangement;
configuring the chamber arrangement to store antimatter therein by using magnetic and/or electrostatic fields; and
arranging for the chamber arrangement and a centre of gravity of the vehicle to be positioned at a relative distance from each other to form a matter-antimatter dipole when in operation, wherein the matter-antimatter dipole provides a propulsion force to the vehicle.

13. The method of claim 12, where the method includes arranging for the antimatter to include positrons.

14. The method of claim 12, wherein the method includes configuring the chamber arrangement to be implemented as a tokamak ring-shaped chamber to store the antimatter along an annular central magnetic axis of the tokamak ring-shaped chamber.

15. The method of claim 12, wherein the method includes arranging for the propulsion arrangement to comprise a laser arrangement, a target that is configured to be stimulated by a laser beam generated by the laser arrangement to produce the antimatter, and a deflector arrangement that is configured to guide the antimatter generated at the target into the chamber arrangement.

16. The method of claim 15, wherein the method includes arranging for the laser arrangement to include one or more Q-switched lasers that are configured to generate light pulses that cause the antimatter to be generated in the target.

17. The method of claim 12, wherein the method includes arranging for the propulsion arrangement further to comprise a particle accelerator arrangement, a target that is configured to be stimulated by a particle beam generated by the particle accelerator arrangement to produce antimatter, and a deflector arrangement that is configured to guide the antimatter generated at the target into the chamber arrangement.

18. The method of claim 15, wherein the method includes arranging for the deflector arrangement to include one or more electromagnetic and/or electrostatic lenses for focusing the antimatter generated at the target as an antimatter beam to feed into the chamber arrangement.

19. The method of claim 12, wherein the method includes configuring the chamber arrangement to be angularly adjustable with respect to the centre of gravity of the vehicle for steering the vehicle.

20. The method of claim 12, wherein the method includes using at least one of rocket thrusters or ion motors for steering the vehicle.

21. The method of claim 12, wherein the method includes increasing the propulsion force provided by the matter-antimatter dipole by adding antimatter to the chamber arrangement, and decreasing the acceleration by dissipating a given amount of the antimatter stored in the chamber arrangement.

22. The method of claim 12, wherein the method includes configuring the propulsion arrangement to provide the propulsion force in a direction that is opposite to a gravitational force of a planet in respect of which the vehicle is operating.
